(19) United States
(12) Patent Application Publication
(10) Pub. No.: US 2024/0298659 A1
(43) Pub. Date: Sep. 12, 2024

(54) SUPPRESSION OF ETHYLENE PRODUCTION IN HARVESTED FRUIT AND OTHER PRODUCE USING CO2-INFUSED WATER

(71) Applicant: CO2 GRO INC., TORONTO (CA)

(72) Inventors: JOHN H ARCHIBALD, HUNTSVILLE (CA); MATTHEW JULIUS, SAUK RAPIDS, MN (US)

(21) Appl. No.: 18/271,938

(22) PCT Filed: Jan. 14, 2022
(86) PCT No.: PCT/CA2022/050052

§ 371 Date: Jul. 12, 2023

Related U.S. Application Data
(60) Provisional application No. 63/137,290, filed on Jan. 14, 2021.

(51) Int. Cl. A23B 7/157; A23B 7/144

(52) U.S. Cl. CPC A23B 7/157; A23B 7/144

(57) ABSTRACT

Fruit ripens as a result of the production of ethylene. It is often desirable to slow the ripening process in order to extend the shelf life of fruit to be sold. One method of slowing the production of ethylene is to increase the concentration of CO₂ in the ambient atmosphere. However, this can endanger humans working with the fruit. Instead, a method of supplying CO₂ to harvested fruit in a way which does not increase the concentration of atmospheric CO₂ is provided. Water is infused with CO₂ and then sprayed onto the fruit. The invention can more generally be applied to other grocery produce so as to reduce spoilage of the produce.

### FIELD OF INVENTION

This invention relates to food production, and in particular to the ripening of harvested fruit and other grocery produce.

### BACKGROUND

As part of the life cycle of fruit-bearing plants, fruit that they produce begins to ripen. When the vascular tissue of a plant cuts off circulation to the fruit from the rest of the plant, the cells in the fruit begin to go inactive. However, even then individual cells within the fruit can continue chemically for a short period of time, even though vascularly separated from the rest of the organism. During this process ethylene is produced. Ethylene stimulates other cells in the same fruit to also begin the “ripening/dying” process.

This process can also be triggered by harvesting of the fruit. Harvesting breaks the vascular lines sustaining the fruit and connecting the fruit to the rest of the plant. The cells in the fruit begin to go inactive and begin to produce ethylene, starting ripening of the fruit. The harvested fruit continues to ripen, including during storage, transportation, and retail. This can be desirable, because by the time the fruit reaches the retail stage it is ripe or close to ripe, and ready for consumption by a consumer.

This can also lead to waste. There can be a narrow window in the whole harvesting, storage, transport, and retail time frame before fruit becomes overripened and more difficult to sell. If not purchased, overripened fruit is usually discarded. One method of slowing the ripening process in harvested fruit is to expose the harvested fruit to CO₂. The presence of CO₂ slows the production of ethylene and hence slows the ripening process. The harvested fruit is typically exposed to an increased amount of CO₂ in the surrounding atmosphere.

However, increasing the amount of CO₂ in atmosphere surrounding harvested fruits can be dangerous to humans who share that atmosphere. It would be desirable to expose harvested fruit to CO₂ in a way that does not increase the risk to humans.

### SUMMARY

According to one embodiment of the invention, a method of slowing ripening of harvested fruit is provided. CO₂ gas is infused into water so as to create CO₂-infused water. The harvested fruit is repeatedly sprayed with the CO₂-infused water. In one embodiment, the CO₂ gas is infused into the water using hollow carbon fibers. The hollow carbon fibers may create bubbles of CO₂ of about 0.2 μm in diameter.

According to another embodiment of the invention, a method of slowing spoilage of grocery produce is provided. CO₂ gas is infused into water so as to create CO₂-infused water. The grocery produce is repeatedly sprayed with the CO₂-infused water. In one embodiment, the CO₂ gas is infused into the water using hollow carbon fibers. The hollow carbon fibers may create bubbles of CO₂ of about 0.2 μm in diameter.

By delivering high concentrations of CO₂ to harvested fruit through spraying the fruit with CO₂-infused water, ethylene production within the fruit is suppressed, leading to a slowing₂down of the ripening process, without increasing atmospheric CO₂ concentrations. This allows more time to pass between harvesting the fruit and consumption, which can reduce food wastage, in a way which does not increase the risk to humans. The invention can more generally be used with other grocery produce, so as to reduce spoilage of the produce.

### DETAILED DESCRIPTION OF THE PREFERRED EMBODIMENTS

Broadly, CO₂ gas is infused in water to produce CO₂-infused water. The CO₂-infused water is then applied to harvested fruit by spraying the CO₂-infused water onto the harvested fruit.

According to one embodiment of the invention, water is infused with CO₂ to create CO₂-infused water. The CO₂ is infused into the water in an amount that results in maximum concentration, about 1.4 g/L at room temperature.

The CO₂ is preferably infused into the water using hollow carbon fibers. Hollow carbon fibers create very small bubbles, or nano bubbles, on the order of 0.2 μm in diameter. The small surface area of the CO₂ nano bubbles allows very quick and efficient gas adsorption into the water.

The CO₂-infused water is then sprayed onto harvested fruit, preferably in the form of water droplets of size 50 to 150 μm diameter. The CO₂-infused water is preferably sprayed so as to cover substantially the entire harvested fruit so as to maximize diffusion of CO₂ into the cells of the fruit, although less than entire coverage will still result in diffusion of CO₂ into the cells of the fruit and a slowing of the ripening process. The spraying is preferably carried out repeatedly with a period of 30 to 60 minutes between sprayings, each for a duration of 5 to 10 seconds, although the period between spraying and the duration of individual sprayings will vary depending on the size of the harvested fruit. The spraying regimen is continued until the fruit is sold, although there will likely be pauses in the spraying regimen such as when consumers are present.

The invention is particularly advantageous if the fruit is sprayed with the CO₂-infused water while on display for purchase by consumers in a retail store. In such an environment, it is very difficult to use increased atmospheric CO₂ levels to diffuse CO₂ into harvested fruit without endangering humans, at least to effective concentrations of CO₂. By spraying fruit in a retail environment with CO₂-infused water, ethylene production and hence ripening in the fruit can be slowed without endangering humans, thereby extending the shelf life of the fruit.

The invention has been described as using hollow carbon fibers to infuse the CO₂ gas in the water. Alternatively, other CO₂ infusion methods can be used, such as the use of air stones. But depending on the method of CO₂ infusion used, large quantities of gas can be lost to the atmosphere as large bubbles of CO₂ rise through the water before being adsorbed. The use of hollow carbon fibers and the resulting nano bubbles increases the amount of gas adsorbed by the water.

The invention has been described in which the spraying is done with CO₂-infused water droplets of 50 to 150 μm diameter. Other water droplet sizes may be used, but these are less efficient. If the water droplet is too small, then the water can drift in air currents and not all of it will reach the fruit, or the CO₂ may leave the solution because there is too high a drop in pressure as the water passes through the nozzle of the sprayer, or both. If the water droplet is too large then the water droplet may not adhere to the harvested fruit because the water droplet bounces off or rolls off the fruit, and a film of CO₂-infused water does not cover the fruit. In either case (too small droplets or too large droplets), transfer of CO₂ into the harvested fruit through the surface of the fruit is less effective when spraying is carried out with the CO₂-infused water. However, the invention is still advantageous in that CO₂ will still enter the cells of the fruit and suppress the production of ethylene, and therefore slow the ripening process, while minimizing increasing the CO₂ of the surrounding atmosphere, but will be less than ideal than use of water droplets of 50 to 150 μm diameter.

The invention has been described as spraying the CO₂-infused water so as to cover substantially the entire harvested fruit. This may not always be possible, due for example to positioning of the harvested fruit or to time constraints. In such a case the invention will still be advantageous in that CO₂ will still enter the cells of the fruit and suppress the production of ethylene, and therefore slow the ripening process, while minimizing increasing the CO₂ of the surrounding atmosphere, but will be less than ideal than full exposure of the harvested fruit to the CO₂-infused water.

The invention has been described as spraying the CO₂-infused water onto harvested fruit. Alternatively, the CO₂-infused water may be sprayed onto other grocery produce to be sold, such as vegetables. This reduces the production of ethylene in this other grocery produce, which increases the shelf life of the grocery produce before spoilage occurs.

The embodiments presented are exemplary only and persons skilled in the art would appreciate that variations to the embodiments described above may be made without departing from the spirit of the invention. The scope of the invention is solely defined by the appended claims.

I/We claim:

1. A method of slowing ripening of harvested fruit, comprising:
infusing CO₂ gas into water so as to create CO₂-infused water;
spraying the harvested fruit with the CO₂-infused water; and
repeatedly spraying the harvested fruit with the CO₂-infused water.

2. The method of claim 1 wherein infusing CO₂ gas into water comprises using hollow carbon fibers.

3. The method of claim 2 wherein the hollow carbon fibers create bubbles of CO₂ of about 0.2 μm in diameter.

4. The method of claim 1 wherein repeatedly spraying the harvested fruit with the CO₂-infused water is carried out with a period of 30 to 60 minutes, each spraying being for a duration of 5 to 10 seconds.

5. The method of claim 1 wherein infusing CO₂ gas into water comprises infusing CO₂ gas to a concentration of about 1.4 g/L of water.

6. The method of claim 1 wherein spraying the harvested fruit with the CO₂-infused water comprises spraying the CO₂-infused water in droplets of 50 to 150 μm diameter.

7. The method of claim 1 wherein spraying the harvested fruit with the CO₂-infused water comprises spraying the harvested fruit while the harvested fruit is on display for purchase by consumers.

8. A method of slowing spoilage of grocery produce, comprising:
infusing CO₂ gas into water so as to create CO₂-infused water;
spraying the grocery produce with the CO₂-infused water; and
repeatedly spraying the grocery produce with the CO₂-infused water.

9. The method of claim 8 wherein infusing CO₂ gas into water comprises using hollow carbon fibers.

10. The method of claim 9 wherein the hollow carbon fibers create bubbles of CO₂ of about 0.2 μm in diameter.

11. The method of claim 8 wherein repeatedly spraying the grocery produce with the CO₂-infused water is carried out with a period of 30 to 60 minutes, each spraying being for a duration of 5 to 10 seconds.

12. The method of claim 8 wherein infusing CO₂ gas into water comprises infusing CO₂ gas to a concentration of about 1.4 g/L of water.

13. The method of claim 8 wherein spraying the grocery produce with the CO₂-infused water comprises spraying the CO₂-infused water in droplets of 50 to 150 μm diameter.
